(19) United States
(12) Patent Application Publication
(10) Pub. No.: US 2004/0185197 A1
(43) Pub. Date: Sep. 23, 2004

(54) Production of hollow articles

(76) Inventor: Jan Petrus Human, Somerset West (ZA)

Correspondence Address: STITES & HARBISON PLLC, 1199 NORTH FAIRFAX STREET, SUITE 900, ALEXANDRIA, VA, 22314, US

(21) Appl. No.: 10/485,649

(22) PCT Filed: Aug. 1, 2002
(86) PCT No.: PCT/ZA02/00123

(30) Foreign Application Priority Data
Aug. 3, 2001 (GB) 0118925.7
Mar. 20, 2002 (GB) 0206538.1

(51) Int. Cl. B29C 45/00; F16L 1/00

(52) U.S. Cl. 428/34.1; 264/328.12

(57) ABSTRACT

A core structure (10) is disclosed for making a preform with an integral hollow handle. The core structure includes an elongate body (12) from which two retractable elements (26, 28) protrude. The mechanism for retracting and extending the elements (26, 28) is within the body (12) and is operated by members (32, 34) which protrude from one end of the body (12). The preform produced by the core structure, and the bottle blown from the preform, are also disclosed.

### FIELD OF THE INVENTION

THIS INVENTION relates to the production of hollow articles.

### BACKGROUND TO THE INVENTION

Many bottles are blow moulded or stretch blow moulded using a procedure that involves the production of what is called a preform. The preform is injection moulded and has, in the neck region, an external shape which conforms to the shape of the neck of the bottle to be produced. The preform is hollow and generally has the shape of a test tube.

The second phase of the production procedure comprises placing the heated preform in a blow mould, the preform being gripped in the neck region. Compressed air or gas is blown into the softened preform so that it expands to the configuration of the mould. In some production procedures the preform is stretched longitudinally by a so-called stretch pin.

A method of making hollow-handled bottles using materials such as PP, PE and PVC is to extrude a heated tube of plastics, clamp it at the bottom and blow it into a blow mould. To make the hollow handle, while the material is still soft, two rods in the mould are moved together so that parts of two sides of the bottle are squeezed between the rods and welded together, resulting in a bigger part (the bottle) and a smaller part (the handle).

After the bottle is removed from the mould, the “welded” portion is punched out or trimmed away to leave a hole between the bottle and the handle. A disadvantage of this process is that weak points are introduced at the weld lines. This method cannot be used with PET because it does not “weld” at the temperature at which the above process takes place.

To overcome this problem some bottles are produced by forming two half shells each of which includes part of the handle. The shells are then welded together. A disadvantage of welding is that there is weakness where the two halves meet. This method cannot be used with PET which will not weld.

As a consequence PET bottles have to be formed by blow moulding a moulded preform which itself is produced by injection moulding. If a handle is required, it has to be fitted to the blow moulded bottle.

The present invention seeks to overcome the above described inability of conventional methods to produce PET bottles with integral hollow handles. The method and tool construction of the present invention are not, however, solely for the purpose of producing bottles of PET but can be used with other synthetic plastics materials that can be blown from a preform

### BRIEF DESCRIPTION OF THE INVENTION

According to one aspect of the present invention there is provided a core structure for use in manufacturing a preform, the core structure comprising an elongate body having a side wall, a first element having a retracted position in which it lies within said body and an extended position in which it protrudes from said side wall, a second element having a retracted position in which it lies within said body and an extended position in which it protrudes from said side wall, said elements abutting when both are in their extended positions thereby to form a continuous bar which defines with said body a passageway which passes between said body and the extended elements, and means for extending and retracting said elements.

According to a further aspect of the present invention there is provided a method of moulding a preform which method comprises inserting a core structure as defined into a mould, extending said elements to form said passageway, closing said mould so that a bar structure of the mould passes through said passageway and a space having the shape of the preform remains between said core structure and said mould, injecting molten synthetic plastics material into said space to form a preform, retracting said elements and opening the mould.

According to another aspect of the present invention there is provided a core structure comprising an elongate body including a main part having a side wall and a co-axial end part, a first element having a retracted position in which it lies within said body and an extended position in which It protrudes from said side wall, a second element having a retracted position in which it lies within said body and an extended position in which It protrudes from said side wall, said elements abutting when both are in their extended positions thereby to form a continuous bar which defines with said body a passageway which passes between said body and the extended elements, means for extending and retracting said elements, a passage in said body for connection to a source of blowing medium and means for displacing said end part with respect to the main part along the common axis of said parts thereby to enable the effective length of the body to be varied.

According to a still further aspect of the present invention there is provided a method of manufacturing a blow moulded article which method comprises inserting a core structure as defined in the preceding paragraph into a pre-form mould, extending said elements to form said passageway, closing said mould so that a bar structure of the mould passes through said passageway and a space having the shape of the preform remains between said core structure and said mould, injecting molten synthetic plastics material into said space to form a preform, retracting said elements and opening the pre-form mould, transferring the core and moulded preform to a blow moulding cavity having the shape of the article being manufactured, feeding blowing medium to said passage to expand the preform, and displacing said end part away from the main part thereby to stretch the preform.

The method can include the step of heating the core to soften the preform.

According to yet another aspect of the present invention there is provided a preform which comprises a hollow generally cylindrical body, the hollow interior of the body being open at one end and closed at the other, the preform further including a hollow tubular handle, the elongate space within the hollow handle opening at both ends thereof into the hollow interior of the body.

According to another aspect of the present invention there is provided a preform which comprises cylindrical walling which bounds an elongate hollow space, said space being open at one end and closed at the other, tubular walling forming a handle and bounding an elongate space, said tubular walling being moulded integrally with said cylindrical walling at two locations spaced apart along the length of the cylindrical walling and the elongate space within the tubular walling communicating at both ends thereof with said hollow space bounded by the cylindrical walling.

### BRIEF DESCRIPTION OF THE DRAWINGS

For a better understanding of the present invention, and to show how the same may be carried into effect, reference will now be made, by way of example, to the accompanying drawings in which:

FIG. 1 is a pictorial view of a core structure;

FIG. 2 is an “exploded” pictorial view of the core structure of FIG. 1;

FIG. 3 is a side elevation of a preform produced on the tool of FIGS. 1 and 2 and from which a bottle with a hollow handle can be blown;

FIGS. 4a and 4b are elevations at right angles to that of FIG. 3 and show two different handle configurations; and

FIG. 5 illustrates a blow moulded bottle.

### DETAILED DESCRIPTION OF THE DRAWINGS

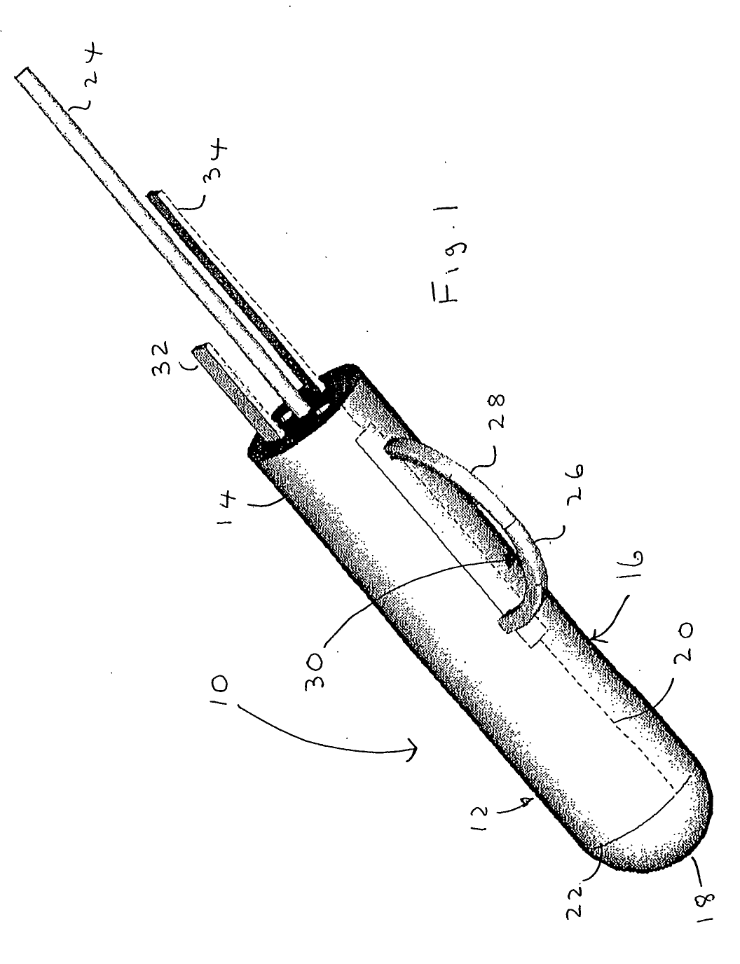

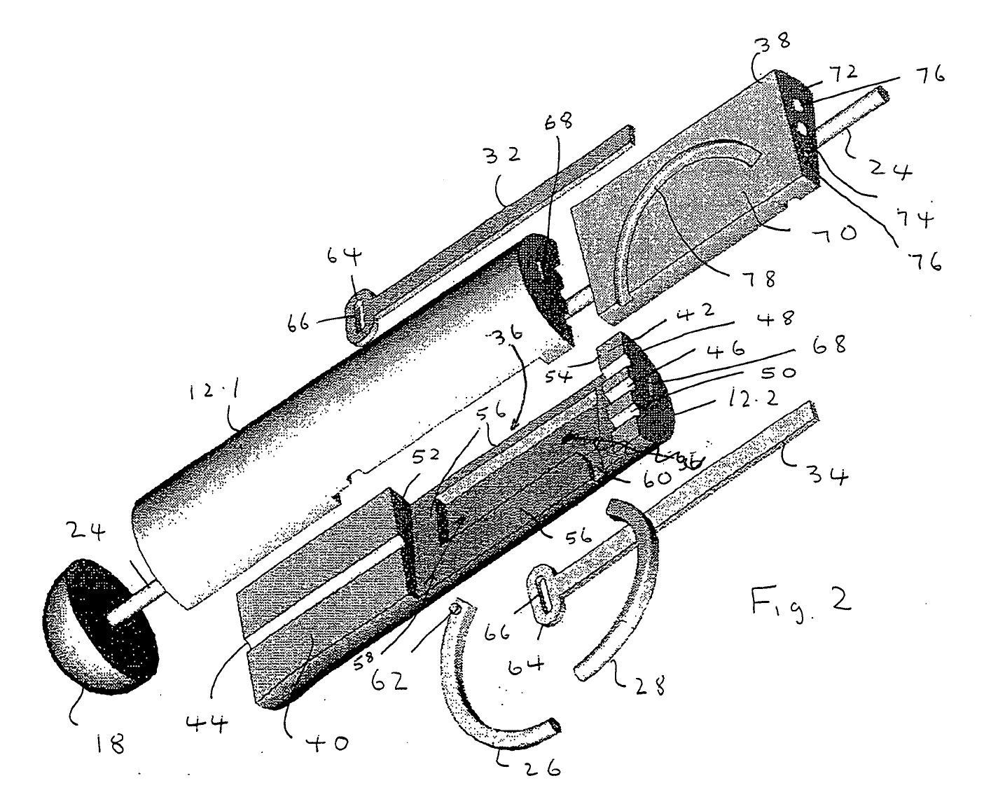

The core structure 10 illustrated in FIG. 1 comprises an elongate body 12 which has a generally cylindrical side wall 14. The body 12 is in two parts, the main part being designated 16 and an end part being designated 18. The main part 16 is generally cylindrical and comprises two semi-cylindrical half shells which abut along the split line 20. The split line between the main part 16 and the end part 18 is designated 22 and it will be seen, particularly from FIG. 2, that the end part 18 is in the form of a hemisphere. It could, however, be in the form of part of a hemisphere. An operating rod 24 is connected to the end part 18 and passes through the main part 16. Two handle forming elements 26 and 28 protrude from the body 12. The elements 26 and 28 are both arcuate in form and, in the extended position shown in FIG. 1, abut one another to form a loop. There is a passageway 30 which passes between the body 12 and the extended elements 26, 28. Actuating members 32 and 34 protrude from the end of the body 12 on opposite sides of the rod 24. The elements 26 and 28 taper from the body 12 to their free ends.

In FIG. 2 the two semi-cylindrical shells which make up the body 12 are designated 12.1 and 12.2. The shell 12.1 is a mirror image of the shell 12.2 and as a consequence only the shell 12.2 will be described in detail. The flat face of the shell 12.2 is formed with a recess generally designated 36, the recess 36 serving to receive a block 38. The provision of the recess 36 leaves a planar area 40 on one side thereof and another planar area 42 on the other side thereof. A semi-circular groove 44 in the area 40 and a semi-circular groove 46 in the area 42 co-operate, when the shells 12.1, 12.2 are placed in face-to-face contact, with the corresponding grooves of the shell 12.1 to form a passageway for the operating rod 24.

Two further semi-circular grooves 48 and 50 are provided in the area 42. These co-operate with the corresponding semi-circular grooves 48 50 of the shell 12.1 to form flow passages. One of these passages can be connected to a source of cooling water and the other of these passages can be connected to a source of blowing medium such as air for blowing the pre-form. This will be described in more detail hereinafter.

The recess 36 is bounded by two end walls 52, 54 and by a flat rectangular surface 56 which bounds a well 58. There is a slot 60 in the surface 56 which leads from externally of the body 12 into the well 58.

Each element 26, 28 is arcuate in form and has a pin 62 at that end thereof which remains permanently within the body 12. Only the pin 62 of the element 26 is visible in FIG. 2.

Each actuating member 32, 34 is in the form of a flat bar with a head 64 at one end. There is a slot 66 in each head, each slot 66 being elongate in the direction transverse to the length of the actuating member 32, 34 in which it is formed. The head 64 of the actuating member 34 slides in the well 58 and the actuating member 32 slides in the corresponding well of the shell 12.1. The pins 62 are in the slots 66. The members 32, 34 slide in rectangular section slits 68 In the shells 12.1, 12.2.

The block 38, in section, is triangular but with the apex removed. Thus the main surfaces 70 of the block (only one of which surfaces is visible) diverge from one another and the end surfaces 72 are generally triangular in shape with the apex removed.

The block has three bores 74, 76 therein. The centre bore 74 receives the rod 24. The bores 76 line-up with the grooves 48 and 50 and form extensions of the passages through which coolant and blowing air are fed.

The surfaces 70 each have arcuate grooves 78 therein for receiving the elements 26, 28. Part of the length of each element 26, 28 is in the groove 78 and a further part of each element, when the elements are extended, passes through the slots 60 to the outside of the body 12.

In use, the core construction, with the elements 26 and 28 extended as shown in FIG. 1, is placed in an injection mould which includes a bar structure which passes through the passageway 30. The space around the core construction, and between it and the mould, is then filled with molten synthetic plastics material. The core and mould are then cooled to freeze the plastics material.

The actuating member 32 is then pulled out of the body 12 so that, via the pin 62 and slot 64, it displaces the element 26 in an arcuate movement which is clockwise as viewed in FIG. 2. The length of the slot 66 permits this movement to take place, the pin 62 sliding along the slot 66 as it moves along the groove 78. Thus the element 26 is retracted into the body. Simultaneously, the actuating member 34 is pushed into the body 12 so that it displaces the element 28, again via its pin 62 and the slot 66 in the element 34, in an anti-clockwise arcuate movement into that one of the slots 78 of the block 38 which cannot be seen in the drawings.

Once the elements 26, 28 have been retracted, the preform and core structure are transferred to the mould in which the bottle is to be blown. This mould has, for example, the shape of the bottle shown in FIG. 5.

The core structure and the preform can be heated if necessary before the core and preform enter the blow mould.

If the blowing method is stretch blow moulding, the rod 24 is then pushed through the main body 12 to displace the end part 18 away from the main body. This stretches the now softened preform and simultaneously blowing air is supplied so that it enters the gap between the body 12 and the part 18. This expands the preform to the shape of the mould cavity. The core structure can now be withdrawn through the neck of the blown bottle and the blown bottle ejected from the mould cavity. In some procedures stretching of the preform is not required.

It will be understood that plastics material must not enter between the abutting elements 26, 28. Mechanical forces exerted on the members 32, 34 hold them in closed contact. The members 32, 34 can be displaced by pneumatic or hydraulic cylinders, screw drives or in any other suitable way.

Because of the dimensions of the body 12 illustrated, the elements 26 and 28 are curved to enable them fully to retract into the body whilst still having sufficient length to provide a handle of the desired dimensions. The elements 26 and 28 can be straight and meet at the apex of a triangle if the body 12 is of sufficient diameter.

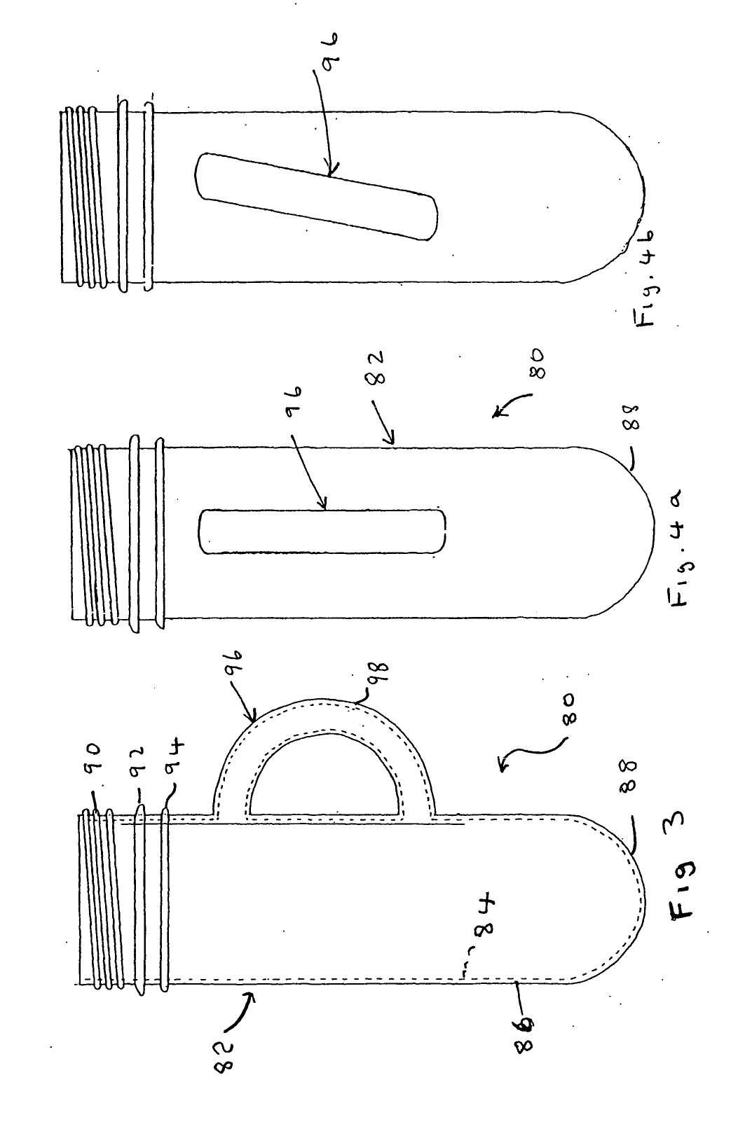

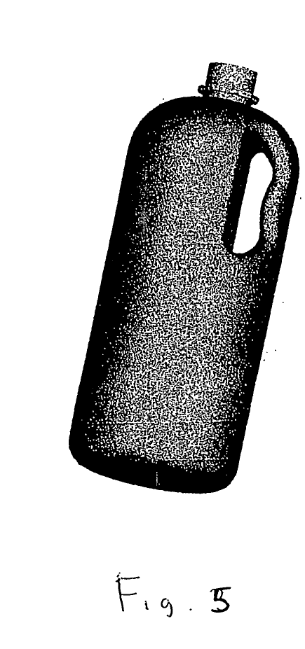

Turning now to FIGS. 3, 4a and 4b, the preform 80 illustrated comprises a cylindrical body 82 which has a central bore 84. The bore 84 is bounded over the full extent of its length by a cylindrical wall 86 and is closed at one end by an end wall 88.

The upper part of the external surface of the preform is configured with a thread 90 and, in the illustrated form, with two protruding ribs 92, 94. This part of the preform is not blown and eventually forms the portion of the neck of the bottle onto which the closure cap (not shown) is screwed. For illustrative purposes the bottle of FIG. 5 is shown with a single rib.

The preform includes a handle 96 which, as best seen in FIG. 3, is of curved, approximately semi-circular form. The handle 96 is hollow and bounded by generally tubular walling 98. The hollow interior of the preform handle 96 opens at each end into the bore 84.

The handle 96 can be parallel to the axis of the preform, as shown in FIG. 4a or skew to the axis of the preform (see FIG. 4b) depending on the configuration of the retractable arms and the cavities provided therefore in the body 12.

In an alternative form the core can be removed from the preform and the preform then transferred to the blow mould. In this construction the stretching components e.g. the end part 18 and the rod 24 are omitted.

1. A core structure for use in manufacturing a preform, the core structure comprising an elongate body having a side wall, a first element having a retracted position in which it lies within said body and an extended position in which it protrudes from said side wall, a second element having a retracted position in which it lies within said body and an extended position in which it protrudes from said side wall, said elements abutting when both are in their extended positions thereby to form a continuous bar which defines with said body a passageway which passes between said body and the extended elements, and means for extending and retracting said elements.

2. A core structure as claimed in claim 1, wherein each of said elements is arcuate in shape.

3. A core structure as claimed in claim 1 or 2, and including actuating members which are reciprocable with respect to the body and which co-operate with parts of said elements which are within the body to displace said elements between their extended and retracted positions.

4. A core structure as claimed in claim 1, 2 or 3 and including passageways in said body for enabling coolant to be fed through the body.

5. A core structure as claimed in any preceding claim, wherein said body comprises a co-axial main part and an end part, there being means for displacing said end part with respect to the main part along the common axis of said parts whereby a gap opens up between said parts and the effective length of the body is varied.

6. A core structure as claimed in claim 5 and including a passage in said body for connection to a source of blowing medium, said passage leading to said gap.

7. A method of moulding a preform which method comprises inserting a core structure as claimed in any preceding claim into a mould, extending said elements to form said loop, closing said mould so that a bar structure of the mould passes through said passageway and a space having the shape of the preform remains between said core structure and said mould, injecting molten synthetic plastics material into said space to form a preform, retracting said elements and opening the mould.

8. A core structure for use in manufacturing a preform, the core structure comprising an elongate body including a main part having a side wall and a co-axial end part, a first element having a retracted position in which it lies within said body and an extended position in which it protrudes from said side wall, a second element having a retracted position in which it lies within said body and an extended position in which it protrudes from said side wall, said elements abutting when both are in their extended positions thereby to form a continuous bar which defines with said body a passageway which passes between said body and the extended elements, means for extending and retracting said elements, a passage in said body for connection to a source of blowing medium, and means for displacing said end part with respect to the main part along the common axis of said parts thereby to enable the effective length of the body to be varied.

9. A method of manufacturing a blow moulded article which method comprises inserting a core structure as claimed in claim 8 into a pre-form mould, extending said elements to form said passageway, closing said mould so that a bar structure of the mould passes through said passageway and a space having the shape of the preform remains between said core structure and said mould, injecting molten synthetic plastics material into said space to form a preform, retracting said elements and opening the pre-form mould, transferring the core and moulded preform to a blow moulding cavity having the shape of the article being manufactured, feeding blowing medium to said passage to expand the preform, and displacing said end part away from the main part thereby to stretch the preform.

10. A method as claimed in claim 9 and including the step of heating the core to soften the preform.

11. A preform which comprises a hollow generally cylindrical body, the hollow interior of the body being open at one end and closed at the other, the preform further including a hollow tubular handle, the elongate space within the hollow handle opening at both ends thereof into the hollow interior of the body.

12. A preform which comprises cylindrical walling which bounds an elongate hollow space, said space being open at one end and closed at the other, tubular walling forming a handle and bounding an elongate space, said tubular walling being moulded integrally with said cylindrical walling at two locations spaced apart along the length of the cylindrical walling and the elongate space within the tubular walling communicating at both ends thereof with said hollow space bounded by the cylindrical walling.
